(19) United States
(12) Patent Application Publication
(10) Pub. No.: US 2022/0070539 A1
(43) Pub. Date: Mar. 3, 2022

(54) PREVENTING SKIPPING OF ADVERTISING CONTENT

(71) Applicant: ARRIS Enterprises LLC, Suwanee, GA (US)

(72) Inventor: Krishna Prasad Panje, Bangalore (IN)

(73) Assignee: ARRIS Enterprises LLC, Suwanee, GA (US)

(21) Appl. No.: 17/349,486

(22) Filed: Jun. 16, 2021

Related U.S. Application Data
(60) Provisional application No. 63/070,929, filed on Aug. 27, 2020.

(51) Int. Cl. H04N 21/472; H04N 21/234; H04N 21/81

(52) U.S. Cl. CPC H04N 21/47217; H04N 21/812; H04N 21/23418

(57) ABSTRACT

Methods and systems of preventing skipping of advertising content are shown and disclosed. In one embodiment, the method includes providing one or more multimedia streams to an Internet protocol (IP) client and receiving a HTTP range request or time seek associated with the one or more multimedia streams from the IP client. The method additionally includes determining proximity of an upcoming targeted advertising (TAD) boundary in the one or more multimedia streams when the HTTP range request or time seek is received and/or determining whether the HTTP range request or time seek is for multimedia content that is after an upcoming targeted advertising (TAD) region. The method further includes responding to the HTTP range request or time seek based on the above determination.

### CROSS REFERENCE TO RELATED APPLICATIONS

This application claims the benefit of U.S. Provisional Patent Application Ser. No. 63/070,929 filed Aug. 27, 2020.

### BACKGROUND

The subject matter of this application relates to providing advertising content in multimedia streams, in particular systems and methods to prevent skipping of advertising content, such as targeted advertising content, during streaming of multimedia content by Internet protocol (IP) clients.

Gateway products, over-the-top (OTT) servers, third party OTT content delivery networks (CDNs), and other products provide IP streaming of content to IP clients. The content may be live or recorded, is indicated or identified by a Uniform Resource Identifier (URI) (e.g., Uniform Resource Locator (URL)), and may be delivered over to the IP clients adaptively (e.g., HTTP Live Streaming (HLS) or Dynamic Adaptive Streaming Over HTTP (DASH)) or non-adaptively (e.g., Digital Living Network Alliance (DLNA)). An IP client typically tunes to a channel by sending a request to the server, such as via a HTTP Get, on a published URI or a playlist. Multiple System Operator (MSO) gateways and set top boxes (e.g., IP set top boxes) also may stream content to IP clients (e.g., smart phones, gaming devices, etc.).

Multiple System Operators and content producers use targeted advertising technology to focus on the traits, interests, and preferences of a consumer based, for example, on the consumer's activity on the Internet. Splicing or tuned transitions are used in multimedia streams to jump from network content to advertisement content and back to network content. However, IP clients are able to fast forward, seek, or skip the advertisement content, which limits the effectiveness of that content. What is desired, therefore, are systems and/or methods of preventing or inhibiting skipping of advertising content, such as targeted advertising, during streaming of multimedia content by Internet protocol (IP) clients.

### BRIEF DESCRIPTION OF THE DRAWINGS

For a better understanding of the invention, and to show how the same may be carried into effect, reference will now be made, by way of example, to the accompanying drawings, in which:

FIG. 1 is a high-level block diagram of an example of a network for preventing skipping of advertising content;

FIG. 2 is a flowchart illustrating an example process of preventing skipping of advertising content; and

FIG. 3 is a block diagram of an example of a hardware configuration operable to prevent skipping of advertising content.

### DETAILED DESCRIPTION

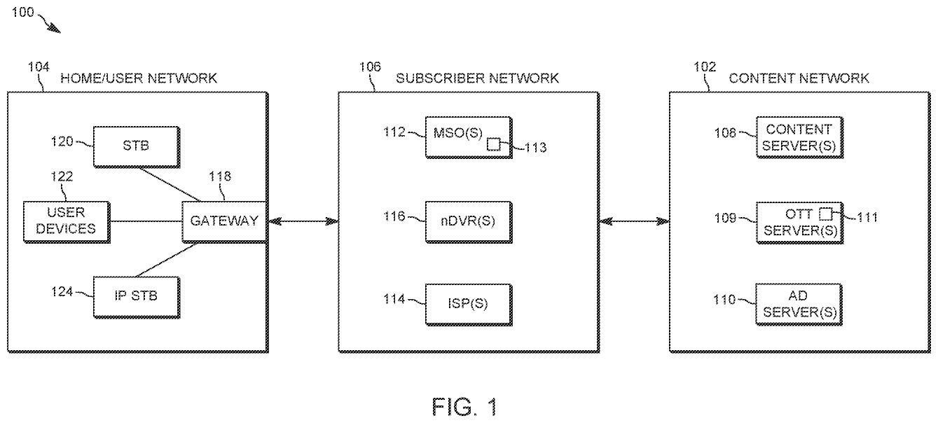

Referring to FIG. 1, an example network environment 100 for providing content from a content network 102 to a home or user network 104 via a provider, access, or subscriber network 106, and for preventing skipping of advertising content by IP clients in the home or user network. Content includes any type of video or audio media, such as movies, television shows, music, radio, advertisements, etc.

Content network 102 includes one or more content servers 108, one or more over-the-top servers 109, and one or more advertisement servers 110. In some embodiments, one or more over-the-top servers 109 include a content monitoring/marking component or apparatus 111, which includes software, hardware, and/or firmware capable of monitoring and/or marking content, such as monitoring and/or marking content for advertising boundaries and/or advertising regions. Each advertising region may, for example, be defined by two advertising boundaries (e.g., a “start” boundary and an “end” boundary with advertising content contained between or within those two boundaries). The advertising region may include one or more advertisements within its two advertising boundaries. The content, over-the-top, and advertisement servers store content that is provided to home network 104. Content server(s) 108 provide content via a multiple system operator (MSO) and/or an internet service provider. Over-the-top servers (OTT) 109 provide content only via over the top streaming for at least one client device of the home network. Advertising server(s) 110 provide advertising content, such as targeted advertising content.

Subscriber network 106 includes one or more Multiple System Operator (MSO) systems 112, which includes multiple cable TV systems and/or direct satellite TV systems. For example, MSO system 112 may include one or more headends, regional headends, a network architecture of fiber optic, twisted pair, and/or co-axial lines, and/or amplifiers. In some embodiments, one or more MSO systems 112 include a content monitoring/marking component or apparatus 113, which includes software, hardware, and/or firmware capable of monitoring and/or marking content from content network 102, such as monitoring and/or marking multimedia content for advertising boundaries and/or regions. Subscriber network 112 also includes one or more Internet Service Providers (ISP) 114. Each ISP 114 includes a Point of Presence (POP) that connect to Network Access Points (NAP), such as via routers and a T3 backbone. In the example shown in FIG. 1, subscriber network 106 includes one or more network Digital Video Recorders (nDVRs) 116, which may be part of and/or separate from MSO systems 112. Various content from content network 102 may be recorded and/or stored on nDVRs 116 based on requests made by users or subscribers. Subscriber network 106 may include other components not explicitly shown in FIG. 1, such as transcoders, streamers, just-in-time (JIT) packagers, etc.

Home/user network 104 includes a gateway 118, a set top box 120, user devices 122, and an Internet Protocol (IP) set top box 124. Set top box 120 is operable to connect to a television to deliver television services through traditional terrestrial, satellite, and cable formats. Set top box 120 may include a digital video recorder and/or may have a graphic user interface (GUI) that may be assessed by the user via the television to which set top box 120 is connected. User devices 122 may be any device that may receive content, such as smart phones, mobile phones, tablet computers, smart watches and other wearables, gaming systems, etc. The user devices may have a GUI that may be accessed by the user via the screen on the device. IP set top box 124 is operable to connect to a television over the Internet instead of being delivered through traditional terrestrial, satellite, and cable formats. The IP set top box may include a digital video recorder and/or may have a GUI that may be accessed by the user via the television to which the IP set top box is connected.

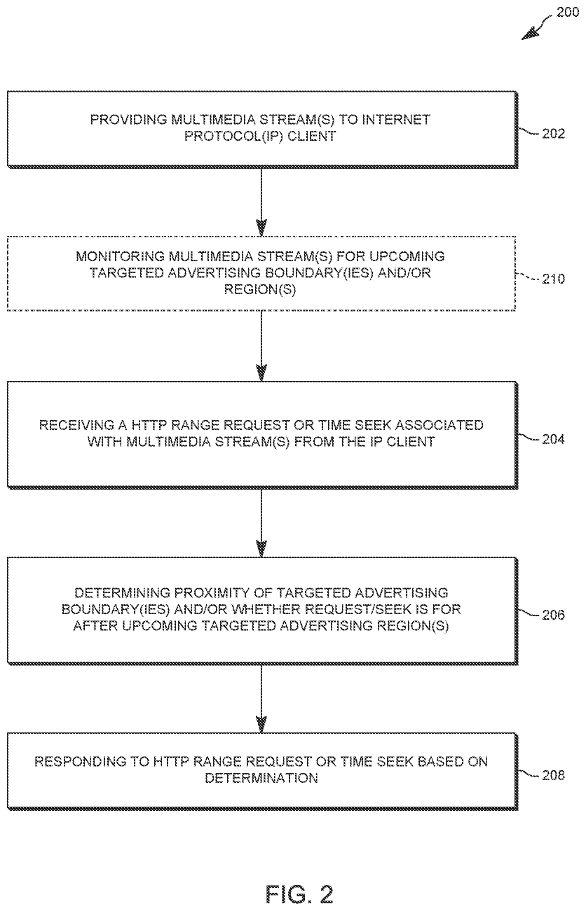

Referring to FIG. 2, a flowchart is shown of an example method or process 200 of preventing skipping of advertising content, which may be performed, for example, by MSO system 112, OTT server(s) 109, content monitoring/marking components 111 and/or 113, and/or gateway 118. At 202, one or more multimedia streams are provided to an IP client, such as user device(s) 122 or IP set top box 124. At 204, a HTTP range request or time seek associated with the one or more multimedia streams is received from the IP client. For example, a graphical user interface on the user device or IP set top box may be used to send a HTTP range request or time seek to the servers.

At 206, a determination is made regarding the proximity of a first advertising boundary, such as an upcoming targeted advertising (TAD) boundary, when the HTTP range request or time seek is received or in response to receiving the HTTP range request or time seek. In some embodiments, there may be a predetermined time window (e.g., 5, 10, or 15 seconds) and the determination is made whether the upcoming TAD boundary is within the predetermined time window when the HTTP range request or time seek is received. In some embodiments, proximity may be based on whether the IP client has already retrieved a content segment containing the upcoming TAD boundary and/or TAD region, such as prior to when the HTTP range request or time seek is received. Alternately, or additionally, a determination is made regarding whether the HTTP range request or time seek is for multimedia content that is past, after, beyond, or downstream an upcoming targeted advertising region. In other words, a determination is made whether the user is attempting to skip over the upcoming TAD region to multimedia content that is past, after, beyond, or downstream that TAD region.

At 208, a response to the HTTP range request or time seek is made based on the determination at 206. In some embodiments, the response may be to provide last known transport stream buffer location when the upcoming TAD boundary or the upcoming TAD region is determined to be within the predetermined time window, when the IP client already has retrieved a content segment containing the upcoming TAD boundary and/or TAD region prior to when the HTTP range request or time seek is received, and/or when it is determined that the HTTP range request or time seek is for multimedia content that is past, after, beyond, or downstream the upcoming TAD region. In other embodiments, the response may be to provide a no content response when the upcoming TAD boundary or the upcoming TAD region is determined to be within the predetermined time window, when the IP client already has retrieved a content segment containing the upcoming TAD boundary and/or TAD region prior to when the HTTP range request or time seek is received, and/or when it is determined that the HTTP range request or time seek is for multimedia content that is past, after, beyond, or downstream the upcoming TAD region. In some embodiments, the response may be to provide the content segment containing the upcoming TAD boundary and/or TAD region when the upcoming TAD boundary or the upcoming TAD region is determined to be within the predetermined time window and/or when it is determined that the HTTP range request or time seek is for multimedia content that is past, after, beyond, or downstream the upcoming TAD region.

Method 200 may, in some embodiments, include, at 210, monitoring multimedia stream(s) for upcoming TAD boundary(ies) and/or TAD region(s). For examples, monitoring may be performed on streaming buffer(s) and/or playlist(s) of the multimedia stream(s) for upcoming TAD boundary(ies) and/or TAD region(s). Method 200 may, in some embodiments, include marking positions of the upcoming TAD boundary(ies) and/or TAD region(s), such as during or based on the above monitoring. When the positions are marked as described above, the determination step may be based on those marked positions. For example, determining proximity of an upcoming TAD boundary or TAD region may be based on a marked position of that upcoming TAD boundary or TAD region when the HTTP range request or time seek is received. The monitoring and/or marking may be performed, for example, on the server side by noting and/or determining the advertisement splice points in the transports streams, noting and/or determining the discontinuities or gaps in the streams, and/or reading and/or interpreting the advertisement metadata that contains advertisement time stamps within the stream(s). Although FIG. 2 shows particular steps for a process of preventing skipping of advertising content, other examples of the process may add, omit, replace, repeat, and/or modify one or more steps.

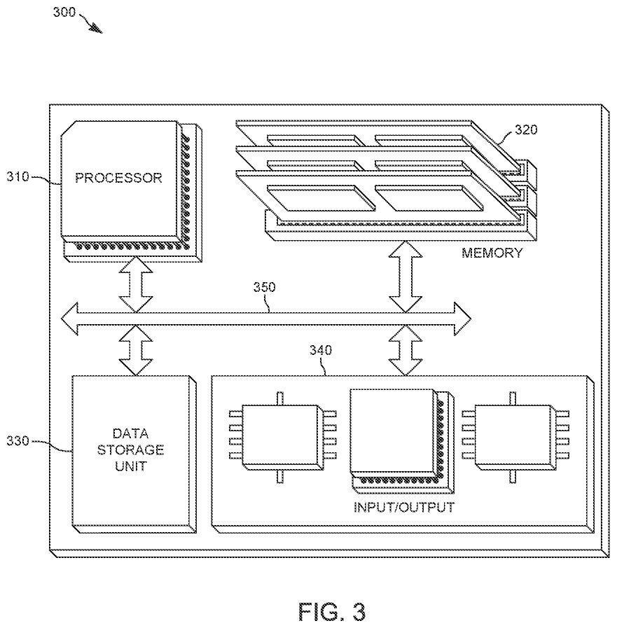

Referring to FIG. 3, a hardware configuration 300 operable to facilitate automatically updating shared content is shown. The hardware configuration may be configured to implement or execute one or more of the processes performed by any of the various components, engines, modules, and devices described in the present disclosure, including OTT servers 109, MSO system 112, gateway 118, and/or monitoring/marking components 111 and/or 113. The hardware configuration 300 may include a processor 310, a memory 320, a storage device 330, and an input/output device 340. Each of the components 310, 320, 330, and 340 may, for example, be interconnected using a system bus 350. The processor 310 may be capable of processing instructions for execution within the hardware configuration 300. In one implementation, the processor 310 may be a single-threaded processor. In another implementation, the processor 310 may be a multi-threaded processor. The processor 310 may be capable of processing instructions stored in the memory 320 or on the storage device 330.

The memory 320 may store information within the hardware configuration 300. In one implementation, the memory 320 may be a computer-readable medium. In one implementation, the memory 320 may be a volatile memory unit. In another implementation, the memory 320 may be a non-volatile memory unit. In some implementations, the storage device 330 may be capable of providing mass storage for the hardware configuration 300. In one implementation, the storage device 330 may be a computer-readable medium. In various different implementations, the storage device 330 may, for example, include a hard disk device, an optical disk device, flash memory or some other large capacity storage device. In other implementations, the storage device 330 may be a device external to the hardware configuration 300.

The input/output device 340 provides input/output operations for the hardware configuration 300. In embodiments, the input/output device 340 may include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a CPE device, IP device, mobile device, or other device. In embodiments, the input/output device may include driver devices configured to send communications to, and receive communications from an advertisement decision system, an advertisement media source, and/or a CDN.

The methods, systems, and apparatuses described in this disclosure enable the identification and retrieval of one or more preferred or requested media renditions of multimedia content. A subscriber device may maintain a list of media attributes preferred by the subscriber device and/or one or more users with access to the subscriber device, wherein the list includes preferred media attributes in order from the most requested/received attribute to the least requested/received attribute. When the subscriber device receives a request for multimedia content, the subscriber device may identify one or more media attributes preferred by the subscriber, and media renditions of the multimedia content in each of the identified attributes may be downloaded to the subscriber device.

The subject matter of this disclosure, and components thereof, may be realized by instructions that upon execution cause one or more processing devices to carry out the processes and functions described above. Such instructions may, for example, comprise interpreted instructions, such as script instructions, e.g., JavaScript or ECMAScript instructions, or executable code, or other instructions stored in a computer readable medium.

Implementations of the subject matter and the functional operations described in this specification may be provided in digital electronic circuitry, or in computer software, firmware, or hardware, including the structures disclosed in this specification and their structural equivalents, or in combinations of one or more of them. Embodiments of the subject matter described in this specification may be implemented as one or more computer program products, i.e., one or more modules of computer program instructions encoded on a tangible program carrier for execution by, or to control the operation of, data processing apparatus.

A computer program (also known as a program, software, software application, script, or code) may be written in any form of programming language, including compiled or interpreted languages, or declarative or procedural languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows may also be performed by, and apparatus may also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory may be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the claims below. For example, the actions recited in the claims may be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of preventing skipping of advertising content, comprising:
providing one or more multimedia streams to an Internet protocol (IP) client;
receiving a HTTP range request or time seek associated with the one or more multimedia streams from the IP client;
determining proximity of an upcoming targeted advertising (TAD) boundary in the one or more multimedia streams when the HTTP range request or time seek is received; and
responding to the HTTP range request or time seek based on the determined proximity.

2. The method of claim 1, wherein determining proximity of an upcoming targeted advertising (TAD) boundary in the one or more multimedia streams when the HTTP range request or time seek is received includes determining whether the upcoming TAD boundary is within a predetermined time window when the HTTP range request or time seek is received.

3. The method of claim 2, wherein responding to the HTTP range request or time seek based on the determined proximity includes providing last known transport stream buffer location when the upcoming TAD boundary is determined to be within the predetermined time window.

4. The method of claim 2, wherein responding to the HTTP range request or time seek based on the determined proximity includes providing a no content response when the upcoming TAD boundary is determined to be within the predetermined time window.

5. The method of claim 1, further comprising monitoring the one or more multimedia streams for upcoming TAD boundaries.

6. The method of claim 5, wherein monitoring the one or more multimedia streams for upcoming TAD boundaries includes monitoring a streaming buffer or playlist of the one or more multimedia streams for the upcoming TAD boundaries.

7. The method of claim 6, further comprising marking positions of the upcoming TAD boundaries in a playlist of the one or more multimedia streams.

8. The method of claim 7, wherein determining proximity of an upcoming targeted advertising (TAD) boundary in the one or more multimedia streams when the HTTP range request or time seek is received includes determining proximity of the upcoming TAD boundary based on a marked position of the upcoming TAD boundary in the playlist when the HTTP range request or time seek is received.

9. The method of claim 1, whether determining proximity of an upcoming targeted advertising (TAD) boundary in the one or more multimedia streams when the HTTP range request or time seek is received includes determining whether the IP client retrieved a content segment containing the upcoming TAD boundary prior to when the HTTP range request or time seek is received.

10. The method of claim 9, wherein responding to the HTTP range request or time seek based on the determined proximity includes providing last known transport stream buffer location in response to the determination that the IP client retrieved a content segment containing the upcoming TAD boundary prior to when the HTTP range request or time seek is received.

11. The method of claim 9, wherein responding to the HTTP range request or time seek based on the determined proximity includes providing a no content response in response to the determination that the IP client retrieved a content segment containing the upcoming TAD boundary prior to when the HTTP range request or time seek is received.

12. A method of preventing skipping of advertising content, comprising:
providing one or more multimedia streams to an Internet protocol (IP) client;
receiving a HTTP range request or time seek associated with the one or more multimedia streams from the IP client;
determining whether the HTTP range request or time seek is for multimedia content that is after an upcoming targeted advertising (TAD) region; and
responding to the HTTP range request or time seek based on the determination.

13. The method of claim 12, wherein responding to the HTTP range request or time seek based on the determination includes providing last known transport stream buffer location when it is determined that the HTTP range request or time seek is for multimedia content that is after the upcoming TAD region.

14. The method of claim 12, wherein responding to the HTTP range request or time seek based on the determination includes providing a no content response it is determined that the HTTP range request or time seek is for multimedia content that is after the upcoming TAD region.

15. The method of claim 12, further comprising monitoring the one or more multimedia streams for upcoming TAD regions.

16. The method of claim 15, wherein monitoring the one or more multimedia streams for upcoming TAD regions includes monitoring a streaming buffer or playlist of the one or more multimedia streams for the upcoming TAD regions.

17. The method of claim 16, further comprising marking positions of the upcoming TAD regions in a playlist of the one or more multimedia streams.

18. The method of claim 17, wherein determining whether the HTTP range request or time seek is for multimedia content that is after an upcoming targeted advertising (TAD) region includes determining whether the HTTP range request or time seek is for multimedia content that is after the upcoming TAD region based on a marked location of the upcoming TAD region in the playlist when the HTTP range request or time seek is received.
